(19) United States
(12) Patent Application Publication
(10) Pub. No.: US 2022/0221561 A1
(43) Pub. Date: Jul. 14, 2022

(54) LIDAR DEVICE

(71) Applicant: Robert Bosch GmbH, Stuttgart (DE)

(72) Inventors: Jan Sparbert, Rutesheim (DE); Matthias Baier, Lehrensteinsfeld (DE)

(21) Appl. No.: 17/615,347

(22) PCT Filed: May 25, 2020
(86) PCT No.: PCT/EP2020/064403

§ 371 Date: Nov. 30, 2021

(30) Foreign Application Priority Data
Jun. 4, 2019 (DE) 10 2019 208 070.7

(51) Int. Cl. G01S 7/481; G02B 27/00

(52) U.S. Cl. CPC G01S 7/4813; G02B 27/0006

(57) ABSTRACT

A LIDAR device. The LIDAR device includes a housing; and an essentially flat first optical element formed from glass and situated in a side wall of the housing.

### FIELD

The present invention relates to a LIDAR device. The present invention further relates to a method for manufacturing a LIDAR device.

### BACKGROUND INFORMATION

LIDAR sensors will become established in the coming years in implementing highly automated driving functions on expressways and in the urban setting. One essential property of these sensors is that the expected performance may be achieved only if the optical exit window facing the surroundings is essentially free of contaminants and/or coverings.

The recognition of contaminants and/or coverings is conventional, in principle, for many sensors today and is implemented to some extent. For LIDAR sensors, however, available solutions demonstrate significant weaknesses. For example, spray nozzles are common, with the aid of which the removal of contaminants is attempted using high pressure, a cleaning effect not always being reliable, and the water consumption also being very high.

For small optical sensors, for example cameras, the wiped-over outlet lens may be made of glass. Glass meets the requirements of scratch resistance and durability during wiping operation. For large optical systems, such as headlights and LIDAR sensors, the wiped-over area is manufactured from transparent plastic (e.g., polycarbonate (PC), Makrolon, polymethyl methacrylate (PMMA), etc.). However, they do not come close to meeting the requirements of scratch resistance and durability during wiping operations.

German Patent Application No. DE 10 2016 123 637 A1 describes a device for condensation removal and/or deicing of a radar device and/or a camera device and/or a headlight of a vehicle, the device being provided with at least one heating element for heating compressed air and/or at least one compressed air conduit.

German Patent Application No. DE 10 2015 210 465 A1 describes an improved radar housing in a vehicle.

German Patent Application No. DE 10 2012 015 260 A1 describes a device for the condensation removal and/or deicing of a radar device of a vehicle.

Heating devices are available in the related art for transparent surface elements. For example, German Patent Application No. DE 10 2012 017 264 A1 describes a windshield, which is provided with an anti-fog coating, a heating layer being provided in the inner area of the protective glass in one variant.

A heating of a LIDAR protective glass (also referred to as a front cover or cover glass), is described, for example, in German Patent Application No. DE 10 2011 122 345 A1. It discloses a biaxial LIDAR scanner, whose protective glass is partially heated. The transmission window is not heated, while the reception window may be heated.

Optoelectronic 3D scanners are available in different variants. These are understood to be rotating macroscanners, MEMS-based scanners, OPA (optical phase array) LIDAR, flash LIDAR. Common to all aforementioned systems is the fact that they collect emitted laser light. Optical systems exist, which are made up of one or multiple lenses. Common to all of them is the fact that they have a long optical receiving path or a large number of lenses.

### SUMMARY

An object of the present invention is to provide an improved LIDAR device.

According to a first aspect, the present invention provides a LIDAR device. In accordance with an example embodiment of the present invention, the LIDAR device includes:
a housing; and
an essentially flat first optical element formed from glass and situated in a side wall of the housing.

In this way, a LIDAR device is provided, whose outwardly facing optical window (exit window) may be very effectively cleaned using a conventional cleaning device, for example in the form of a wiper element and a spraying device, due to the fact that it is essentially flat and formed from glass. The glass material of the first optical element advantageously very effectively withstands mechanical stresses, so that a high frequency of cleaning operations is supported thereby.

According to a second aspect of the present invention, the object may be achieved by a method for manufacturing a LIDAR device. In accordance with an example embodiment of the present invention, the method includes the steps:
providing a housing; and
providing an essentially flat first optical element formed from glass and situated in the housing.

Preferred specific embodiments of the LIDAR device are disclosed herein.

In one advantageous refinement of the LIDAR device of the present invention, the first optical element has a defined slight outer curvature. A wipeability of the first optical element is also advantageously very effectively possible, due to the defined slight outer curvature.

In a further advantageous embodiment of the LIDAR device in accordance with the present invention, a sealing element is included between the first optical element and the housing. In this way, a good seal is supported between the housing and the first optical element. A good seating of the first optical element in the housing and an easy replaceability of the first optical element are furthermore supported thereby.

A further advantageous refinement of the LIDAR device of the present invention provides that the sealing element is fixed in a groove of the first optical element. The seating or fixing of the first optical element in the housing is even further improved thereby, which is not possible in conventional LIDAR devices including a thin optical element.

A further advantageous refinement of the LIDAR device of the present invention provides that the sealing element is designed as a rubber lip. An easy and proven technical implementation of the sealing element is advantageously made possible thereby.

In a further advantageous embodiment of the LIDAR device of the present invention, a heating device is situated within the first optical element. A further cleaning or water removal or deicing or condensation removal of the first optical element is supported thereby, by means of which the first optical element may be advantageously kept dry essentially continuously.

In a further advantageous specific embodiment of the LIDAR device of the present invention, the first optical element is designed to be flush with the sealing element or to project slightly over the sealing element in a defined manner. A wiping-off process is made possible thereby, with the aid of which cleaning fluid may be effectively wiped off of the edge of the first optical element. An easily carried out change of an angle of inclination of the wiper blade during the course of a wiping cycle is further supported thereby.

In a further advantageous specific embodiment of the LIDAR device of the present invention, the LIDAR device further includes a second optical element, which is situated in the interior of the housing and is designed to be rotatable with respect to the first optical element. In this way, a technical concept of the so-called “variable prism” is made possible, with the aid of which an efficient LIDAR sensor device may be implemented.

In a further advantageous refinement of the LIDAR device of the present invention, a ratio of the radii of curvature of the first optical element to the second optical element is approximately 2:1 to approximately 5:1. In this way, effective radii of curvature, combined with suitable outer dimensions of the LIDAR device, are advantageously made possible, which permit an easy installation of the LIDAR device in motor vehicles.

The present invention, including further features and advantages, is described in detail below on the basis of multiple figures. Identical or functionally equivalent components have the same reference numerals. The figures are intended, in particular, to illustrate the main features of the present invention and are not necessarily shown true to scale.

Described device features are similarly derived from corresponding described method features and vice versa. This means, in particular, that features, technical advantages and explanations relating to the LIDAR device are similarly derived from corresponding explanations, features and advantages of the method for manufacturing a LIDAR device and vice versa.

### BRIEF DESCRIPTION OF THE DRAWINGS

FIG. 1 shows a schematic representation of one specific embodiment of a provided LIDAR device, in accordance with the present invention.

FIG. 2 shows a schematic representation of a further specific embodiment of a provided LIDAR device, in accordance with the present invention.

FIG. 3 shows a schematic representation of one detail of the specific embodiment of the provided LIDAR device from FIG. 2, in accordance with the present invention.

FIG. 4 shows a flowchart of a provided method for manufacturing a LIDAR device, in accordance with an example embodiment of the present invention.

### DETAILED DESCRIPTION OF EXAMPLE EMBODIMENTS

One main feature of the present invention is, in particular, to provide an improved LIDAR device, in particular relating to a cleaning aspect.

For conventional LIDAR devices, a synthetic plastic is generally used as the optical element, for example in the form of polycarbonate (PC) or polymethyl methacrylate (PMMA, “acrylic glass,” “Plexiglas”). These materials have a number of disadvantages with regard to cleaning operations; in particular, they do not tolerate high mechanical or chemical loads and thereby lose their high optical quality over time, due to frequent cleaning operations. An efficiency of the LIDAR device may be significantly reduced in this way.

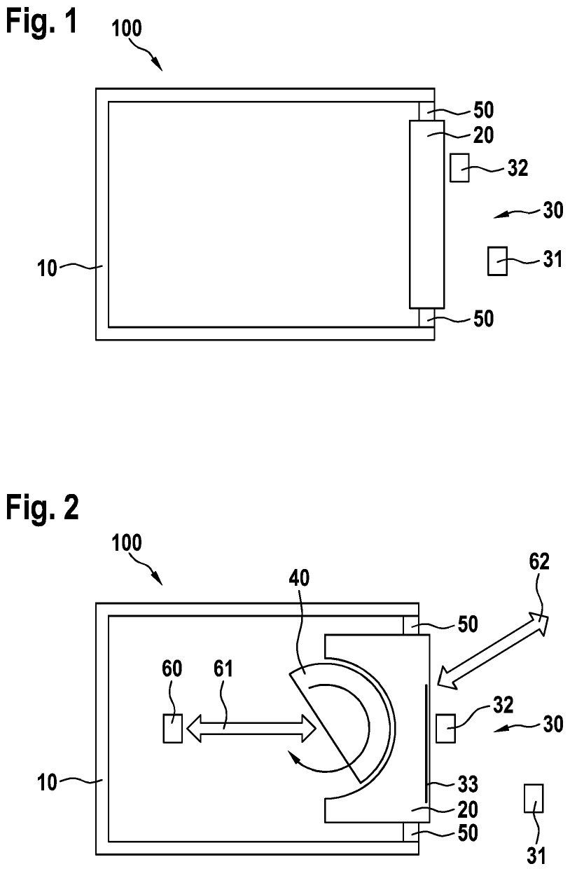

FIG. 1 shows a top view of one specific embodiment of provided LIDAR device 100. A housing 10 is apparent, in which a first optical element 20 is situated as an exit window in a side wall, and thus faces outwardly. First optical element 20 is manufactured from a scratch-resistant and durable glass material and is designed to be essentially flat or slightly curved in a defined manner. A wiping and washing device 32, 31 may advantageously be provided with a simple design for these geometries of first optical element 20.

FIG. 1 shows the variant including a first optical element 20 provided with a flat design. The connection between housing 10 and first optical element 20 is preferably implemented with the aid of a sealing element 50, first optical element 20 being designed in relation to sealing element 50 in such a way that it is designed to be largely flush with sealing element 50 or to project slightly thereover. FIG. 1 shows the variant including a first optical element 20, which is designed to project slightly over sealing element 50. An easily carried out replaceability of first optical element 20 is supported by sealing element 50, by which means LIDAR device 100 may, for example, be cost-effectively repaired.

Due to the flatness of first optical element 20 and its formation from glass, it may be advantageously efficiently and easily cleaned, for example using a conventional cleaning device of a motor vehicle.

A cleaning device 30 for cleaning first optical element 20 is apparent for this purpose. Cleaning device 30 includes at least one wiping device 32 (e.g., a wiper blade) and one washing device 31 (e.g., a spray nozzle including an assigned washing fluid container, which is not illustrated), with the aid of which the washing or cleaning fluid is sprayed onto first optical element 20 and wiped off of first optical element 20 with the aid of wiping device 32. Due to the slight projection of first optical element 20 over sealing element 50, the washing fluid may be completely wiped off of first optical element 20 during wiping.

A heating device 33 in the form of heating wire 3 (not illustrated) may further be optionally provided within first optical element 20, with the aid of which first optical element 20 may be heated and freed of a moisture condensation or of ice in this manner. Heating device 33 situated within first optical element 20 may be designed, for example, as an electrically activatable resistance heater. It is activated to evaporate the moisture condensation or the ice on the outside of first optical element 20 with the aid of thermal energy and to thus keep first optical element 20 for LIDAR device 100 as transparent as possible. A usability or efficiency of LIDAR device 100 may be significantly improved in this way.

A control device, which detects the moisture and/or dirt on the outside of first optical element 20 and thereby activates cleaning device 30 accordingly, is not illustrated.

The glass material of first optical element 20 is extremely stable with respect to high temperatures, great temperature changes and mechanical stresses due to temperature differences. In particular, glass has a high coefficient of thermal conductivity. Due to the high thermal conductivity, the heating wires of the heating device may be provided with a comparatively thin design. Thick heating strips or surface coatings are thus not necessary. Due to the high resistance to temperatures and resulting mechanical stresses, the heating wires of heating device 33 may be operated at very high temperatures, large gaps between the individual heating wires may be provided, and the heating wires may be introduced into the glass of first optical element 20 right below the glass surface. This, in turn, increases the effectiveness of the heating power or improves the optical properties, for example, due to less shading of the optical path due to the heating wires.

First optical element 20 is preferably fixed in housing 10 with the aid of a sealing element 50. Particular advantages result in that sealing element 50 is mounted to the side of optical glass 20, for example in the form of a rubber lip, which may be fixed in a groove (not illustrated) of first optical element 20. This advantageously permits a contaminant and/or a washing fluid and/or rainwater to be wiped off to the side over the surface of first optical element 20 with the aid of wiping device 32, from where it may be subsequently drained off in a targeted manner.

This additionally permits wiping device 32 to wipe past first optical element 20 and in this way to reach a requested reversing point for the contact direction of the wiper lip, which may advantageously increase the lifespan of the wiper lip. It additionally permits high-quality optics when installing LIDAR device 100 in a body of a vehicle (not illustrated), because a uniform and high quality surface is apparent thereby, housing parts of LIDAR device 100 are thus recessed and therefore advantageously not visible. An improved integration of LIDAR device 100 into a vehicle surface is advantageously supported thereby.

FIG. 2 shows a top view of a further specific embodiment of a LIDAR device 100 in the form of a LIDAR sensor for a motor vehicle. It is apparent that, in addition to first optical element 20, a second optical element 40 is now provided, which is designed to be rotatable in the arrow direction in relation to first optical element 20 and in this way conducts beams of a radiation source 60 (e.g., laser) in two beam paths 61, 62 externally into the surroundings. Radiation source 60 may always be active, for example, whenever the flat side of second optical element 40 is facing radiation source 60, while it may be switched off whenever the rounded surface of second optical element 40 is facing radiation source 60.

In this way, a technical, optical principle of a so-called two-part “variable prism” or an “adaptive prism optical element” may be implemented, which permits a very highly geometrically designed or dimensioned first optical element 20 and, in this way, permits a high mechanical sealing force between sealing element 50 and first optical element 20.

A time-of-flight system is implemented in this way, which includes a light emitter and a receiver (not illustrated), via which a beam, which is reflected on objects, is deflected into the surroundings via two-part variable prism 20, 40 and is guided back to the receiver on the same path. A rotation of second optical element 40 results in a change in the deflection of internal beam path 61 into an external beam path 62, which is deflected into the surroundings.

Due to the fact that first optical element 20 is manufactured from glass, a large number of wiping operations or cycles for first optical element 20 is advantageously supported, which is greater by a factor of approximately 100 compared to conventional plastic material, and which may be, for example, some millions of wiping cycles.

The material of first optical element 20 is robust with respect to mechanical damage, aging, chemicals, UV radiation, sand blasting, etc., glass essentially meeting all known requirements. In particular, the glass may sufficiently withstand washing chemicals of washing device 31 and the mechanical stresses of wiping device 32 for a long operating period.

First optical element 20 may be further designed or dimensioned as a glass body in such a way that it does not completely break and/or generate sharp-edged shards when damaged, for example when struck by stones and/or in an accident. No undesirable opening of LIDAR device 100 is advantageously effectuated thereby.

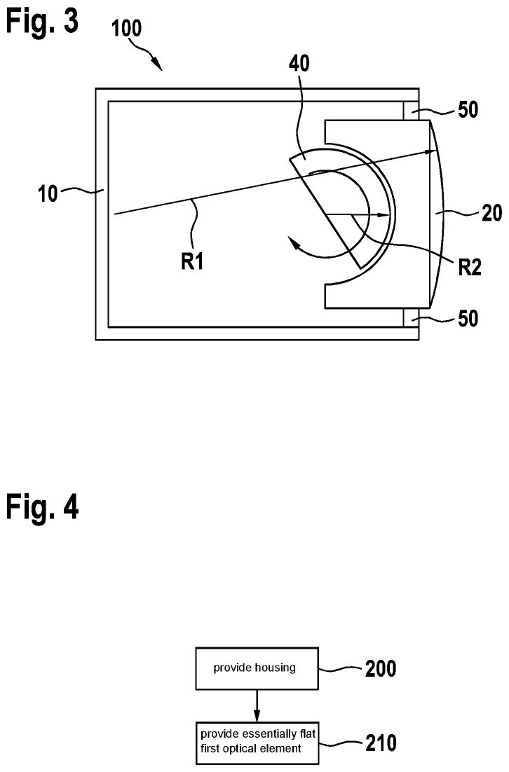

FIG. 3 indicates that a ratio of a radius of curvature R1 of first optical element 20 to a radius of curvature R2 of second optical element 40 may be R1:R2, preferably between approximately 2:1 and approximately 5:1. Radius of curvature R1 of first optical element 20 may be adapted to an aesthetic design and may typically be approximately 10 cm to approximately 50 cm.

Due to the design of the outer surface of first optical element 20, the latter may be very effectively wiped and washed with the aid of wiping device 32, by means of which an optimal cleaning effect may be supported for first optical element 20.

Alternatively, a further technical approach for cleaning device 30 may also be provided, which is not illustrated in the figures. For example, it may be provided that the washing fluid is situated within a vertically closed chamber. The vertically closed chamber is moved over first optical element 20 to be cleaned, by means of which an effective duration of the washing fluid may be advantageously increased and a consumption of the washing fluid simultaneously greatly reduced.

In a further variant, a recognition device may be additionally provided, which may detect a covering, e.g., in the form of moisture, ice, etc., on the outside of first optical element 20, and which is functionally connected to a control device, which is provided for the electrical activation of cleaning device 30. In this way, cleaning device 30 is activated only if a covering on first optical element 20 is recognized by the recognition device.

FIG. 4 shows a schematic sequence of one specific embodiment of the provided method for manufacturing a LIDAR device 100.

In a step 200, a provision of a housing 10 is carried out.

In a step 210, a provision takes place of an essentially flat first optical element 20 formed from glass and situated in housing 10.

Although the present invention was explained in connection with an optoelectronic 3D scanner in the form of a LIDAR sensor for a motor vehicle, it is also possible, for example, to design provided LIDAR device 100 as an optical camera (e.g., in the form of a line scan camera), an optical industrial application in an unclean environment, a robotic application, an application for building surveillance, etc.

Those skilled in the art thus recognize that a multiplicity of modifications is possible without departing from the scope of the present invention, in view of the disclosure herein.

The invention claimed is:

1-10. (canceled)

11. A LIDAR device, comprising:
a housing; and
an essentially flat first optical element formed from glass and situated in a side wall of the housing.

12. The LIDAR device as recited in claim 11, wherein the first optical element has a defined slight outer curvature.

13. The LIDAR device as recited in claim 11, further comprising:
a sealing element between the first optical element and the housing.

14. The LIDAR device as recited in claim 13, wherein the sealing element is fixed in a groove of the first optical element.

15. The LIDAR device as recited in claim 13, wherein the sealing element is a rubber lip.

16. The LIDAR device as recited in claim 10, wherein a heating device is situated within the first optical element.

17. The LIDAR device as recited in claim 13, wherein the first optical element is flush with the sealing element or projects slightly over the sealing element in a defined manner.

18. The LIDAR device as recited in claim 10, further comprising:
a second optical element situated in an interior of the housing and being rotatable with respect to the first optical element.

19. The LIDAR device as recited in claim 18, wherein a ratio of radii of curvature of the first optical element to the second optical element is approximately 2:1 to approximately 5.1.

20. A method for manufacturing a LIDAR device, comprising the following steps:
providing a housing; and
providing an essentially flat first optical element formed from glass and situated in the housing.
